(19) United States
(12) Patent Application Publication
(10) Pub. No.: US 2017/0328729 A1
(43) Pub. Date: Nov. 16, 2017

(54) System To Optimize Sensor Parameters In An Autonomous Vehicle

(71) Applicants: Jiajun ZHU, Sunnyvale, CA (US); David I. FERGUSON, San Francisco, CA (US)

(72) Inventors: Jiajun ZHU, Sunnyvale, CA (US); David I. FERGUSON, San Francisco, CA (US)

(73) Assignee: GOOGLE INC., MOUNTAIN VIEW, CA (US)

(21) Appl. No.: 13/585,432

(22) Filed: Aug. 14, 2012

(51) Int. Cl. G01C 21/36

(52) U.S. Cl. CPC G01C 21/3602

(57) ABSTRACT

Example embodiments disclosed herein relate to receiving, using a computer system in a vehicle, ground truth data that relates to a current state of the vehicle in an environment. A plurality of sensors may be coupled to the vehicle and controlled by a plurality of parameters. The vehicle may be configured to operate in an autonomous mode in which the computer system controls the vehicle in the autonomous mode based on data obtained by the plurality of sensors. The example embodiments also relate to obtaining perceived environment data that relates to the current state of the vehicle in the environment as perceived by at least one of the plurality of sensors, comparing the perceived environment data to the ground truth data, and adjusting one or more of the plurality of parameters based on the comparison.

### BACKGROUND

Unless otherwise indicated herein, the materials described in this section are not prior art to the claims in this application and are not admitted to be prior art by inclusion in this section.

Some vehicles are configured to operate in an autonomous mode in which the vehicle navigates through an environment with little or no input from a driver. Such a vehicle typically includes one or more sensors that are configured to sense information about the environment. The vehicle may use the sensed information to navigate through the environment. For example, if the sensors sense that the vehicle is approaching an obstacle, the vehicle may navigate around the obstacle.

### SUMMARY

In a first aspect, a method is provided. The method includes receiving, using a computer system in a vehicle, ground truth data that relates to a current state of the vehicle in an environment. A plurality of sensors are coupled to the vehicle and are controlled by a plurality of parameters, and the vehicle is configured to operate in an autonomous mode in which the computer system controls the vehicle in the autonomous mode based on data obtained by the plurality of sensors. The method also includes obtaining, using the computer system in the vehicle, perceived environment data that relates to the current state of the vehicle in the environment as perceived by at least one of the plurality of sensors. The method additionally includes comparing, using the computer system in the vehicle, the perceived environment data to the ground truth data. The method further includes adjusting, using the computer system in the vehicle, one or more of the plurality of parameters based on the comparison.

In a second aspect, a vehicle is provided. The vehicle includes a plurality of sensors coupled to the vehicle and controlled by a plurality of parameters. The vehicle also includes a computer system. The computer system is configured to control the vehicle in an autonomous mode based on data obtained by the plurality of sensors. The computer system is also configured to receive ground truth data that relates to a current state of the vehicle in an environment. The computer system is additionally configured to obtain perceived environment data that relates to the current state of the vehicle in the environment as perceived by at least one of the plurality of sensors. The computer system is yet further configured to compare the perceived environment data to the ground truth data, and to adjust one or more of the plurality of parameters based on the comparison.

In a third aspect, a non-transitory computer readable medium having stored therein instructions executable by a computer system in a vehicle is provided. The functions include operating at least one sensor of a vehicle using a first parameter value for a sensor parameter to obtain first sensor data. The functions include receiving ground truth data that relates to a current state of the vehicle in an environment. A plurality of sensors are coupled to the vehicle and are controlled by a plurality of parameters, and the vehicle is configured to operate in an autonomous mode in which the computer system controls the vehicle in the autonomous mode based on data obtained by the plurality of sensors. The functions also include obtaining perceived environment data that relates to the current state of the vehicle in the environment as perceived by at least one of the plurality of sensors. The functions additionally include comparing the perceived environment data to the ground truth data, and adjusting one or more of the plurality of parameters based on the comparison.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a functional block diagram illustrating a vehicle, in accordance with an example embodiment.

FIG. 2 is a vehicle, in accordance with an example embodiment.

FIG. 3A is a top view of an autonomous vehicle operating scenario, in accordance with an example embodiment.

FIG. 3B is a top view of an autonomous vehicle operating scenario, in accordance with an example embodiment.

FIG. 3C is a top view of an autonomous vehicle operating scenario, in accordance with an example embodiment.

FIG. 4 is a block diagram of a method, in accordance with an example embodiment.

FIG. 5 is a schematic diagram of a computer program product, according to an example embodiment.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

A key component of a vehicle driving in autonomous mode is its perception system, which allows the vehicle to perceive and interpret its surroundings while driving. To perceive its surroundings, a vehicle driving in autonomous mode may use various sensors such as laser and radar sensors. For example, an autonomous vehicle may perceive obstacles or other vehicles located on the highway or surface street upon which the autonomous vehicle is traveling. Each sensor may be controlled by parameters to both operate and communicate with other sensors. Sensor parameters may be optimized by collecting sensor produced data and comparing the collected data to known data or ground truth data. Using the known data, the parameter values may be varied to cause the sensors to produce data that more accurately reflects the known data. Once the parameter values have been varied, the vehicle may utilize the parameter values to ensure the sensors of the vehicle, for example, obtain data that accurately reflects the surroundings of the vehicle.

Example embodiments disclosed herein relate to receiving, using a computer system in a vehicle, ground truth data that relates to a current state of the vehicle in an environment, obtaining perceived environment data that relates to the current state of the vehicle in the environment as perceived by at least one of the plurality of sensors, comparing the perceived environment data to the ground truth data, and adjusting one or more of the plurality of parameters based on the comparison.

Within the context of the disclosure, the vehicle may be operable in various modes of operation. Depending on the embodiment, such modes of operation may include manual, semi-autonomous, and autonomous modes. In particular, the autonomous mode may provide steering operation with little or no user interaction. Manual and semi-autonomous modes of operation could include greater degrees of user interaction.

Some methods described herein could be carried out in part or in full by a vehicle configured to operate in an autonomous mode with or without external interaction (e.g., such as from a user of the vehicle). A plurality of sensors may be coupled to the vehicle and may be controlled by a plurality of parameters. The vehicle may be further configured to operate in the autonomous mode in which a computer system in the vehicle controls the vehicle in the autonomous mode based on data obtained by the plurality of sensors. In one example, the vehicle may receive ground truth data that relates to a current state of the vehicle in an environment. For example, the vehicle may be traveling down a road, with other vehicles driving in front of it. The ground truth data may define, for example, external driving conditions, a current state of the vehicle, and a current status of the other vehicles traveling in front of the vehicle. The external driving conditions may include a weather indication, a position of an obstacle in the environment, a position of a landmark in the environment, and/or a terrain map of the environment, for example. Other driving conditions could also be included. The current status of the other vehicles may include information such as the velocity or speed of the other vehicles, and the heading of the other vehicles. Other types of status information could also be received. For example, the ground truth data may indicate that another vehicle is in front of the vehicle heading straight on a two-lane, 10 mile road at a speed of 20 miles-per-hour, and that there is a left-turn slant at mile 5.

The vehicle may obtain perceived environment data that relates to the current state of the vehicle in the environment as perceived by at least one of the plurality of sensors. The perceived environment data may relate to the current state of the vehicle in the environment and may include information regarding external driving conditions (e.g., a terrain map of the road), information about the current state of the vehicle (e.g., revolutions per minute, vehicle speed, current driving lane, fuel level, and brake fluid level, etc.), as well as information about the other vehicles (e.g., the speed of the other vehicles), among other things. For example, as the vehicle continues to travel the heading of the vehicle may be varied by, for example, moving the steering wheel of the vehicle back-and-forth. The steering wheel may be moved autonomously or by the driver of the vehicle, for example. As the heading of the vehicle changes the vehicle may perceive data indicating that the road no longer has a left turn slant and the other vehicle is no longer traveling in front of the vehicle with a straight heading, for example. Based on the comparison, the vehicle may compare the perceived environment data to the ground truth data, and adjust one or more of the plurality of parameters that control the plurality of sensors coupled to the vehicle in a manner so as to reduce a difference between the perceived environment data and the ground truth data. For example, knowing that the road does in fact have a slant at mile 5, and that the other vehicle is traveling in front of the vehicle with a straight heading, the parameter values of the sensors may be adjusted in a manner that allows the sensors to perceive the environment correctly (i.e., the slant at mile 5 and the other vehicle traveling with a straight heading).

Vehicles are also described in the present disclosure. In one embodiment, the vehicle may include elements including a plurality of sensors that are coupled to the vehicle and controlled by a plurality of parameters, and a computer system. The computer system may be configured to perform various functions. The functions may include controlling the vehicle in an autonomous mode based on data obtained by a plurality of sensors. The functions may also include receiving ground truth data that relates to a current state of the vehicle in an environment. The functions may additionally include obtaining perceived environment data that relates to the current state of the vehicle in the environment as perceived by at least one of the plurality of sensors. The functions may further include comparing the perceived environment data to the ground truth data. The functions may yet further include adjusting one or more of the plurality of parameters based on the comparison.

Also disclosed herein is a non-transitory computer readable medium with stored instructions. The stored instructions may be executable by a computing device to cause the computing device to perform functions similar to those described in the aforementioned methods.

There are many different specific methods and systems that could be used to effectuate the methods and systems described herein. Each of these specific methods and systems are contemplated herein, and several example embodiments are described below.

Example systems within the scope of the present disclosure will now be described in greater detail. Generally, an example system may be implemented in or may take the form of an automobile (i.e., a specific type of vehicle). However, an example system may also be implemented in or take the form of other vehicles, such as cars, trucks, motorcycles, buses, boats, airplanes, helicopters, lawn mowers, recreational vehicles, amusement park vehicles, farm equipment, construction equipment, trams, golf carts, trains, and trolleys. Other vehicles are possible as well.

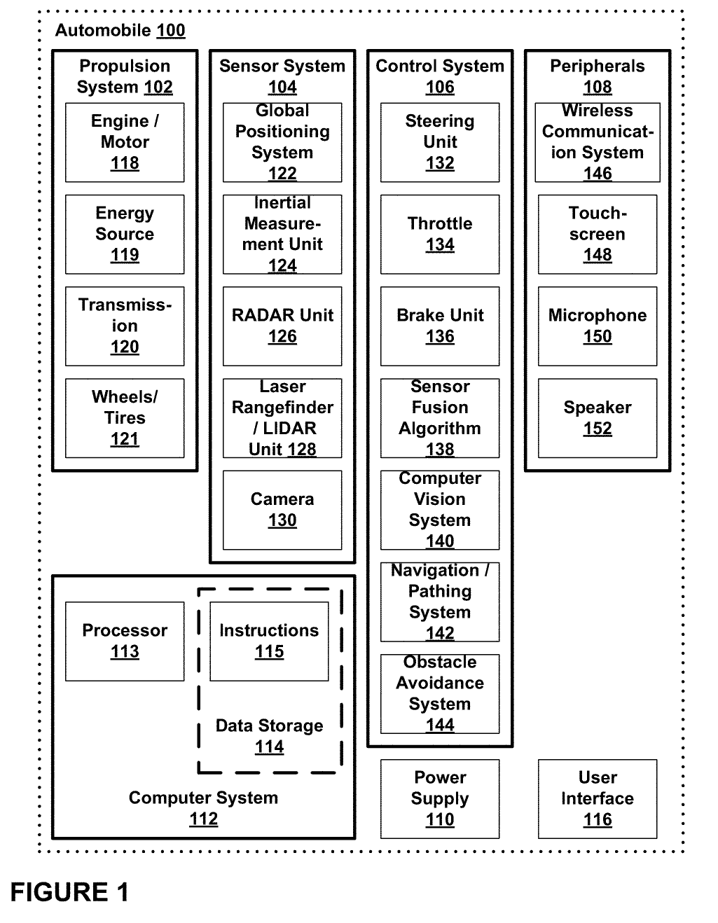

Referring now to the figures, FIG. 1 is a functional block diagram illustrating an automobile (i.e., vehicle) 100, according to an example embodiment. The automobile 100 may be configured to operate fully or partially in an autonomous mode. The automobile 100 may further be configured to operate in the autonomous mode based on data obtained by a plurality of sensors. For example, in one embodiment, the automobile 100 may be operable to receive ground truth data that relates to the current state of the automobile 100 in an environment, obtain perceived environment data that relates to the current state of the automobile 100 in the environment as perceived by at least one of the plurality of sensors, compare the perceived environment data to the ground truth data; and adjust one or more of the plurality of parameters based on the comparison. While in autonomous mode, the automobile 100 may be configured to operate without human interaction.

The automobile 100 could include various subsystems such as a propulsion system 102, a sensor system 104, a control system 106, one or more peripherals 108, as well as a power supply 110, a computer system 112, and a user interface 116. The automobile 100 may include more or fewer subsystems and each subsystem could include multiple elements. Further, each of the subsystems and elements of automobile 100 could be interconnected. Thus, one or more of the described functions of the automobile 100 may be divided up into additional functional or physical components, or combined into fewer functional or physical components. In some further examples, additional functional and/or physical components may be added to the examples illustrated by FIG. 1.

The propulsion system 102 may include components operable to provide powered motion for the automobile 100. Depending upon the embodiment, the propulsion system 102 could include an engine/motor 118, an energy source 119, a transmission 120, and wheels/tires 121. The engine/motor 118 could be any combination of an internal combustion engine, an electric motor, steam engine, Stirling engine, or other types of engines and/or motors. In some embodiments, the engine/motor 118 may be configured to convert energy source 119 into mechanical energy. In some embodiments, the propulsion system 102 could include multiple types of engines and/or motors. For instance, a gas-electric hybrid car could include a gasoline engine and an electric motor. Other examples are possible.

The energy source 119 could represent a source of energy that may, in full or in part, power the engine/motor 118. That is, the engine/motor 118 could be configured to convert the energy source 119 into mechanical energy. Examples of energy sources 119 include gasoline, diesel, other petroleum-based fuels, propane, other compressed gas-based fuels, ethanol, solar panels, batteries, and other sources of electrical power. The energy source(s) 119 could additionally or alternatively include any combination of fuel tanks, batteries, capacitors, and/or flywheels. The energy source 119 could also provide energy for other systems of the automobile 100.

The transmission 120 could include elements that are operable to transmit mechanical power from the engine/motor 118 to the wheels/tires 121. To this end, the transmission 120 could include a gearbox, clutch, differential, and drive shafts. The transmission 120 could include other elements. The drive shafts could include one or more axles that could be coupled to the one or more wheels/tires 121.

The wheels/tires 121 of automobile 100 could be configured in various formats, including a unicycle, bicycle/motorcycle, tricycle, or car/truck four-wheel format. Other wheel/tire geometries are possible, such as those including six or more wheels. Any combination of the wheels/tires 121 of automobile 100 may be operable to rotate differentially with respect to other wheels/tires 121. The wheels/tires 121 could represent at least one wheel that is fixedly attached to the transmission 120 and at least one tire coupled to a rim of the wheel that could make contact with the driving surface. The wheels/tires 121 could include any combination of metal and rubber, or another combination of materials.

The sensor system 104 may include a plurality of sensors configured to sense information about an environment of the automobile 100. For example, the sensor system 104 could include a Global Positioning System (GPS) 122, an inertial measurement unit (IMU) 124, a RADAR unit 126, a laser rangefinder/LIDAR unit 128, and a camera 130. The sensor system 104 could also include sensors configured to monitor internal systems of the automobile 100 (e.g., O₂ monitor, fuel gauge, engine oil temperature). Other sensors are possible as well.

One or more of the sensors included in sensor system 104 could be configured to be actuated separately and/or collectively in order to modify a position and/or an orientation of the one or more sensors.

The GPS 122 may be any sensor configured to estimate a geographic location of the automobile 100. To this end, GPS 122 could include a transceiver operable to provide information regarding the position of the automobile 100 with respect to the Earth.

The IMU 124 could include any combination of sensors (e.g., accelerometers and gyroscopes) configured to sense position and orientation changes of the automobile 100 based on inertial acceleration.

The RADAR unit 126 may represent a system that utilizes radio signals to sense objects within the local environment of the automobile 100. In some embodiments, in addition to sensing the objects, the RADAR unit 126 may additionally be configured to sense the speed and/or heading of the objects.

Similarly, the laser rangefinder or LIDAR unit 128 may be any sensor configured to sense objects in the environment in which the automobile 100 is located using lasers. Depending upon the embodiment, the laser rangefinder/LIDAR unit 128 could include one or more laser sources, a laser scanner, and one or more detectors, among other system components. The laser rangefinder/LIDAR unit 128 could be configured to operate in a coherent (e.g., using heterodyne detection) or an incoherent detection mode.

The camera 130 could include one or more devices configured to capture a plurality of images of the environment of the automobile 100. The camera 130 could be a still camera or a video camera.

The control system 106 may be configured to control operation of the automobile 100 and its components. Accordingly, the control system 106 could include various elements include steering unit 132, throttle 134, brake unit 136, a sensor fusion algorithm 138, a computer vision system 140, a navigation/pathing system 142, and an obstacle avoidance system 144.

The steering unit 132 could represent any combination of mechanisms that may be operable to adjust the heading of automobile 100.

The throttle 134 could be configured to control, for instance, the operating speed of the engine/motor 118 and, in turn, control the speed of the automobile 100.

The brake unit 136 could include any combination of mechanisms configured to decelerate the automobile 100. The brake unit 136 could use friction to slow the wheels/tires 121. In other embodiments, the brake unit 136 could convert the kinetic energy of the wheels/tires 121 to electric current. The brake unit 136 may take other forms as well.

The sensor fusion algorithm 138 may be an algorithm (or a computer program product storing an algorithm) configured to accept data from the sensor system 104 as an input. The data may include, for example, data representing information sensed at the sensors of the sensor system 104. The sensor fusion algorithm 138 could include, for instance, a Kalman filter, Bayesian network, or other algorithm. The sensor fusion algorithm 138 could further provide various assessments based on the data from sensor system 104. Depending upon the embodiment, the assessments could include evaluations of individual objects and/or features in the environment of automobile 100, evaluation of a particular situation, and/or evaluate possible impacts based on the particular situation. Other assessments are possible.

The computer vision system 140 may be any system operable to process and analyze images captured by camera 130 in order to identify objects and/or features in the environment of automobile 100 that could include traffic signals, road way boundaries, and obstacles. The computer vision system 140 could use an object recognition algorithm, a Structure From Motion (SFM) algorithm, video tracking, and other computer vision techniques. In some embodiments, the computer vision system 140 could be additionally configured to map an environment, track objects, estimate the speed of objects, etc.

The navigation and pathing system 142 may be any system configured to determine a driving path for the automobile 100. The navigation and pathing system 142 may additionally be configured to update the driving path dynamically while the automobile 100 is in operation. In some embodiments, the navigation and pathing system 142 could be configured to incorporate data from the sensor fusion algorithm 138, the GPS 122, and one or more predetermined maps so as to determine the driving path for automobile 100.

The obstacle avoidance system 144 could represent a control system configured to identify, evaluate, and avoid or otherwise negotiate potential obstacles in the environment of the automobile 100.

The control system 106 may additionally or alternatively include components other than those shown and described.

Peripherals 108 may be configured to allow interaction between the automobile 100 and external sensors, other automobiles, and/or a user. For example, peripherals 108 could include a wireless communication system 146, a touchscreen 148, a microphone 150, and/or a speaker 152.

In an example embodiment, the peripherals 108 could provide, for instance, means for a user of the automobile 100 to interact with the user interface 116. To this end, the touchscreen 148 could provide information to a user of automobile 100. The user interface 116 could also be operable to accept input from the user via the touchscreen 148. The touchscreen 148 may be configured to sense at least one of a position and a movement of a user's finger via capacitive sensing, resistance sensing, or a surface acoustic wave process, among other possibilities. The touchscreen 148 may be capable of sensing finger movement in a direction parallel or planar to the touchscreen surface, in a direction normal to the touchscreen surface, or both, and may also be capable of sensing a level of pressure applied to the touchscreen surface. The touchscreen 148 may be formed of one or more translucent or transparent insulating layers and one or more translucent or transparent conducting layers. The touchscreen 148 may take other forms as well.

In other instances, the peripherals 108 may provide means for the automobile 100 to communicate with devices within its environment. The microphone 150 may be configured to receive audio (e.g., a voice command or other audio input) from a user of the automobile 100. Similarly, the speakers 152 may be configured to output audio to the user of the automobile 100.

In one example, the wireless communication system 146 could be configured to wirelessly communicate with one or more devices directly or via a communication network. For example, wireless communication system 146 could use 3G cellular communication, such as CDMA, EVDO, GSM/GPRS, or 4G cellular communication, such as WiMAX or LTE. Alternatively, wireless communication system 146 could communicate with a wireless local area network (WLAN), for example, using WiFi. In some embodiments, wireless communication system 146 could communicate directly with a device, for example, using an infrared link, Bluetooth, or ZigBee. Other wireless protocols, such as various vehicular communication systems, are possible within the context of the disclosure. For example, the wireless communication system 146 could include one or more dedicated short range communications (DSRC) devices that could include public and/or private data communications between vehicles and/or roadside stations.

The power supply 110 may provide power to various components of automobile 100 and could represent, for example, a rechargeable lithium-ion or lead-acid battery. In some embodiments, one or more banks of such batteries could be configured to provide electrical power. Other power supply materials and configurations are possible. In some embodiments, the power supply 110 and energy source 119 could be implemented together, as in some all-electric cars.

Many or all of the functions of automobile 100 could be controlled by computer system 112. Computer system 112 may include at least one processor 113 (which could include at least one microprocessor) that executes instructions 115 stored in a non-transitory computer readable medium, such as the data storage 114. The computer system 112 may also represent a plurality of computing devices that may serve to control individual components or subsystems of the automobile 100 in a distributed fashion.

In some embodiments, data storage 114 may contain instructions 115 (e.g., program logic) executable by the processor 113 to execute various automobile functions, including those described above in connection with FIG. 1. Data storage 114 may contain additional instructions as well, including instructions to transmit data to, receive data from, interact with, and/or control one or more of the propulsion system 102, the sensor system 104, the control system 106, and the peripherals 108.

In addition to the instructions 115, the data storage 114 may store data such as roadway maps, path information, among other information. Such information may be used by automobile 100 and computer system 112 at during the operation of the automobile 100 in the autonomous, semi-autonomous, and/or manual modes.

The automobile 100 may include a user interface 116 for providing information to or receiving input from a user of automobile 100. The user interface 116 could control or enable control of content and/or the layout of interactive images that could be displayed on the touchscreen 148. Further, the user interface 116 could include one or more input/output devices within the set of peripherals 108, such as the wireless communication system 146, the touchscreen 148, the microphone 150, and the speaker 152.

The computer system 112 may control the function of the automobile 100 based on inputs received from various subsystems (e.g., propulsion system 102, sensor system 104, and control system 106), as well as from the user interface 116. For example, the computer system 112 may utilize input from the control system 106 in order to control the steering unit 132 to avoid an obstacle detected by the sensor system 104 and the obstacle avoidance system 144. Depending upon the embodiment, the computer system 112 could be operable to provide control over many aspects of the automobile 100 and its subsystems.

The various subsystems' (e.g., propulsion system 102, sensor system 104, and control system 106) elements (e.g., RADAR Unit 126, Brake Unit 136, and Speaker 152) may be controlled by parameters. The subsystem inputs received by the computer system 112 may be generated, for example, based on parameters that allow the various subsystems and their elements to operate. For example, sensor system 104 may utilize parameters including a device type, a detection range, a camera type, and a time value to operate its elements. Other parameters may be associated with the sensor system 104 including a latency, a noise distribution, a sensor bias, a sensor position, a sensor angle, and a sensor operating altitude, for example. Other parameters may be used. The parameter values of the various parameters may be a numeric value, a boolean value, a word, or a range, for example. The parameter values may be fixed or adjusted automatically. Automatic parameter value adjustments may be determined, for example, based on a comparison of known data received by the automobile 100 (information about the automobile 100 and an environment of the automobile 100) to perceived data (information about the automobile 100 and an environment of the automobile 100) obtained by the automobile 100. In a specific embodiment, for example, sensor system 104 may utilize a range parameter for the Laser Rangefinder/LIDAR Unit 128 with a parameter value of “10 feet.” Accordingly, the sensor system 104 may generate an input the computer system 112 causing the computer system 112 to control the Laser Rangefinder/LIDAR Unit 128 to only detect objects within 10 feet.

The components of automobile 100 could be configured to work in an interconnected fashion with other components within or outside their respective systems. For instance, in an example embodiment, the camera 130 could capture a plurality of images that could represent information about a state of an environment of the automobile 100 operating in an autonomous mode. The environment could include another vehicle. The computer vision system 140 could recognize the other vehicle as such based on object recognition models stored in data storage 114.

The computer system 112 may control the automobile 100 in an autonomous mode based on data obtained by a plurality of sensors that are coupled to the automobile 100 and controlled by a plurality of parameters. The computer system 112 may control any of the sensors of the sensor system 104, for example. In one instance, the computer system 112 may control the automobile 100 to cause the sensor system 104 to cause the RADAR unit 126 to obtain sensor data. For example, the RADAR unit 126 may detect an obstacle on the street with the automobile 100, and the automobile 100 may be controlled to avoid a collision with the obstacle. The computer system 112 may also receive ground truth data that relates to a current state of the automobile 100 in an environment. For example, the computer system 112 may receive data indicating the automobile is on a street with other vehicles present that are traveling at 50 miles-per-hour. As the automobile 100 continues to operate, the computer system 112 may control the automobile 100 to continuously operate one or more of the plurality of sensors to obtain perceived environment data that relates to the environment. The computer system 112 may also compare the perceived environment data to the ground truth data, and adjust one or more of the sensor parameters based on the comparison. Other examples of interconnection between the components of automobile 100 are numerous and possible within the context of the disclosure.

Although FIG. 1 shows various components of automobile 100, i.e., wireless communication system 146, computer system 112, data storage 114, and user interface 116, as being integrated into the automobile 100, one or more of these components could be mounted or associated separately from the automobile 100. For example, data storage 114 could, in part or in full, exist separate from the automobile 100. Thus, the automobile 100 could be provided in the form of device elements that may be located separately or together. The device elements that make up automobile 100 could be communicatively coupled together in a wired and/or wireless fashion.

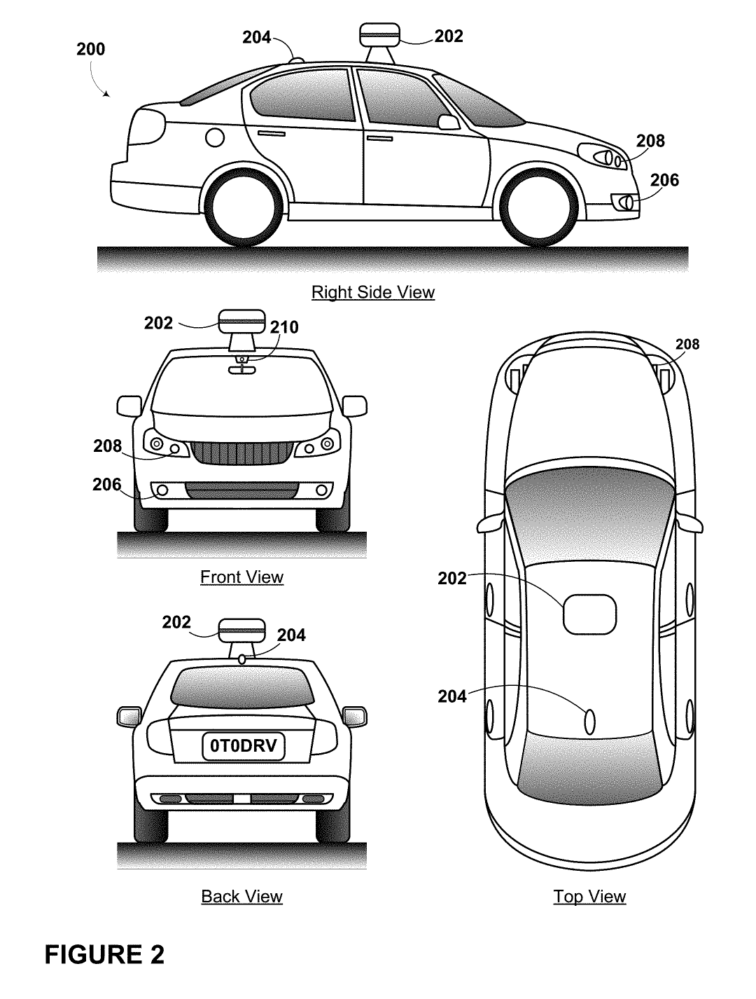

FIG. 2 shows an automobile 200 that could be similar or identical to automobile 100 described in reference to FIG. 1. Although automobile 200 is illustrated in FIG. 2 as a car, other embodiments are possible. For instance, the automobile 200 could represent a truck, a van, a semi-trailer truck, a motorcycle, a golf cart, an off-road vehicle, or a farm vehicle, among other examples.

Depending on the embodiment, automobile 200 could include a sensor unit 202, a wireless communication system 204, a LIDAR unit 206, a laser rangefinder unit 208, and a camera 210. The elements of automobile 200 could include some or all of the elements described for FIG. 1.

The sensor unit 202 could include one or more different sensors configured to capture information about an environment of the automobile 200. For example, sensor unit 202 could include any combination of cameras, RADARs, LIDARs, range finders, and acoustic sensors. Other types of sensors are possible. Depending on the embodiment, the sensor unit 202 could include one or more movable mounts that could be operable to adjust the orientation of one or more sensors in the sensor unit 202. In one embodiment, the movable mount could include a rotating platform that could scan sensors so as to obtain information from each direction around the automobile 200. In another embodiment, the movable mount of the sensor unit 202 could be moveable in a scanning fashion within a particular range of angles and/or azimuths. The sensor unit 202 could be mounted atop the roof of a car, for instance, however other mounting locations are possible. Additionally, the sensors of sensor unit 202 could be distributed in different locations and need not be collocated in a single location. Some possible sensor types and mounting locations include LIDAR unit 206 and laser rangefinder unit 208. Furthermore, each sensor of sensor unit 202 could be configured to be moved or scanned independently of other sensors of sensor unit 202.

The wireless communication system 204 could be located on a roof of the automobile 200 as depicted in FIG. 2. Alternatively, the wireless communication system 204 could be located, fully or in part, elsewhere. The wireless communication system 204 may include wireless transmitters and receivers that could be configured to communicate with devices external or internal to the automobile 200. Specifically, the wireless communication system 204 could include transceivers configured to communicate with other vehicles and/or computing devices, for instance, in a vehicular communication system or a roadway station. Examples of such vehicular communication systems include dedicated short range communications (DSRC), radio frequency identification (RFID), and other proposed communication standards directed towards intelligent transport systems.

The camera 210 may be any camera (e.g., a still camera, a video camera, etc.) configured to capture a plurality of images of the environment of the automobile 200. To this end, the camera 210 may be configured to detect visible light, or may be configured to detect light from other portions of the spectrum, such as infrared or ultraviolet light. Other types of cameras are possible as well.

The camera 210 may be a two-dimensional detector, or may have a three-dimensional spatial range. In some embodiments, the camera 210 may be, for example, a range detector configured to generate a two-dimensional image indicating a distance from the camera 210 to a number of points in the environment. To this end, the camera 210 may use one or more range detecting techniques. For example, the camera 210 may use a structured light technique in which the automobile 200 illuminates an object in the environment with a predetermined light pattern, such as a grid or checkerboard pattern and uses the camera 210 to detect a reflection of the predetermined light pattern off the object. Based on distortions in the reflected light pattern, the automobile 200 may determine the distance to the points on the object. The predetermined light pattern may comprise infrared light, or light of another wavelength. As another example, the camera 210 may use a laser scanning technique in which the automobile 200 emits a laser and scans across a number of points on an object in the environment. While scanning the object, the automobile 200 uses the camera 210 to detect a reflection of the laser off the object for each point. Based on a length of time it takes the laser to reflect off the object at each point, the automobile 200 may determine the distance to the points on the object. As yet another example, the camera 210 may use a time-of-flight technique in which the automobile 200 emits a light pulse and uses the camera 210 to detect a reflection of the light pulse off an object at a number of points on the object. In particular, the camera 210 may include a number of pixels, and each pixel may detect the reflection of the light pulse from a point on the object. Based on a length of time it takes the light pulse to reflect off the object at each point, the automobile 200 may determine the distance to the points on the object. The light pulse may be a laser pulse. Other range detecting techniques are possible as well, including stereo triangulation, sheet-of-light triangulation, interferometry, and coded aperture techniques, among others. The camera 210 may take other forms as well.

The camera 210 could be mounted inside a front windshield of the automobile 200. Specifically, as illustrated, the camera 210 could capture images from a forward-looking view with respect to the automobile 200. Other mounting locations and viewing angles of camera 210 are possible, either inside or outside the automobile 200.

The camera 210 could have associated optics that could be operable to provide an adjustable field of view. Further, the camera 210 could be mounted to automobile 200 with a movable mount that could be operable to vary a pointing angle of the camera 210.

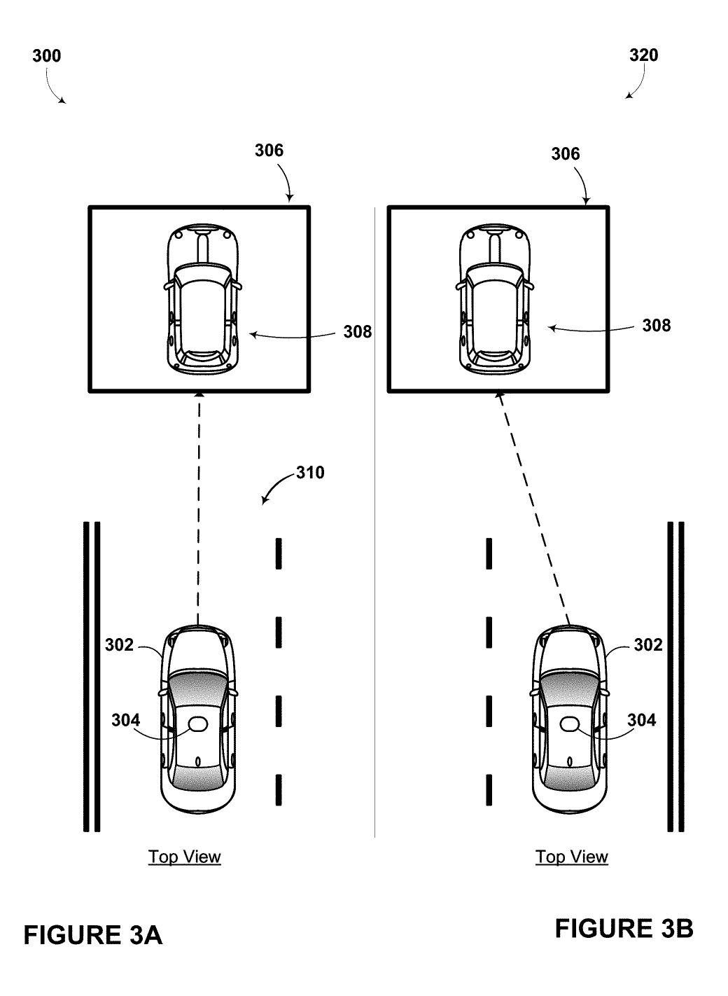

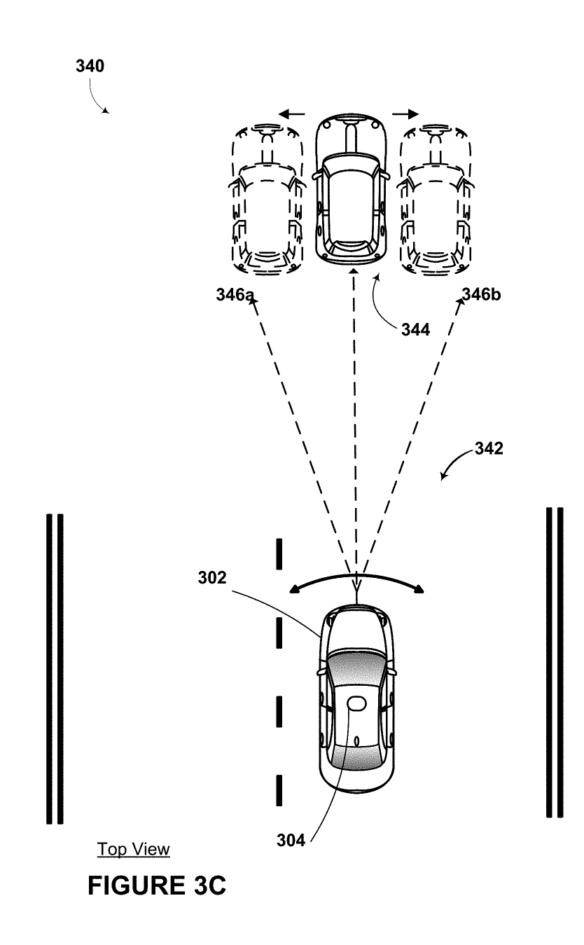

FIG. 3A illustrates a scenario 300 involving a freeway 310 and an automobile 302 operating in an autonomous mode. For example, the automobile 302 may be traveling at 50 miles-per-hour with a zero-degree north heading. The automobile 302 may receive ground truth data that relates to the current state of an environment of the automobile. For example, the automobile 302 may receive data indicating another vehicle 308 is operating in the environment directly in front of the automobile 302. As the automobile 302 continues to operate, the automobile may obtain perceived environment data that relates to the current state of the automobile. To obtain the perceived data, the automobile 302 may use parameters to control one or more of a plurality of sensors coupled to the automobile. For example, the automobile 302 may operate the camera 130 of the automobile 302 sensor unit 304, using a “high-angle” parameter value for a sensor angle parameter, allowing the automobile to capture images of the environment of the automobile 302 from a high-angle. The automobile 302 may operate the camera 130 to capture images of the other vehicle 308, for example. The other vehicle 308 may be captured in a frame-of-reference 306, for example. The sensor data may also include video captured by the camera 130 of the automobile 302, for example. Other sensors may be operated by the automobile 302, and other data may be perceived about the environment of the automobile 302.

FIG. 3B illustrates a scenario 320 involving a freeway 310 and an automobile 302 operating in an autonomous mode. Also like FIG. 3A, the automobile 302 in FIG. 3B is traveling at 50 miles-per-hour. However, in FIG. 3B the camera 130 of the automobile 302 is capturing images in frame-of-reference 306 of the other vehicle 308 indicating the other vehicle 308 is operating slightly to the left of automobile 302 instead of directly in front of it, as indicated by the known ground truth data automobile 302 previously received. Using the ground truth data and the perceived environment data the automobile 302 may compare the perceived environment data to the ground truth data, and based on the comparison, adjust one or more of the plurality of parameters in a manner so as to reduce a difference between the perceived environment data and the ground truth data. The parameters may be adjusted in other manners as well. For example, in FIG. 3B an operating angle of camera 130 of the automobile 302 may be adjusted in a manner that corrects the disparity between the actual location of the other vehicle 308 (i.e., ground truth) and the how the camera 130 captures (i.e., perceives) the other vehicle 308. Continuing with the example above, the sensor angle parameter may be adjusted to “normal-angle,” for example.

FIG. 3C illustrates another scenario according to an example embodiment. In FIG. 3C, automobile 302 is travelling in a lane 342 on a freeway traveling at 50 miles-per-hour at a zero-degree north heading. The automobile 302 may receive ground truth data indicating the presence of another vehicle 344 directly out in front of the automobile 302, traveling at a certain velocity. As automobile 302 continues to operate, for example, the pose may be varied by the computer system of the automobile 302 creating a small perturbation to the heading of the automobile 302. The perturbation to the heading is indicated by the semi-arch arrow shown in the figure. As the pose of the automobile is changed, the automobile 302 may obtain perceived environment data by operating the sensor unit 304 to obtain sensor data. In this example, the automobile 302 may operate LIDAR unit 128. The LIDAR unit 128 of the automobile 302 may sense velocity responses of the other vehicle 344 corresponding to the heading change. In the figure this is depicted as lines 346a and b.

Using the ground truth data and the perceived environment data the automobile 302 may compare the perceived environment data to the ground truth data, and based on the comparison, adjust one or more of the plurality of parameters in a manner so as to reduce a difference between the perceived environment data and the ground truth data. For example, knowing that the other vehicle 344 is traveling straight down the road, a latency parameter of the LIDAR unit 128 may be varied in attempt to produce sensor measurements (i.e., LIDAR unit 128 data measurements) that most closely resemble a straight motion for the other vehicle 344. Other scenarios of sensor parameter optimization are possible and contemplated herein.

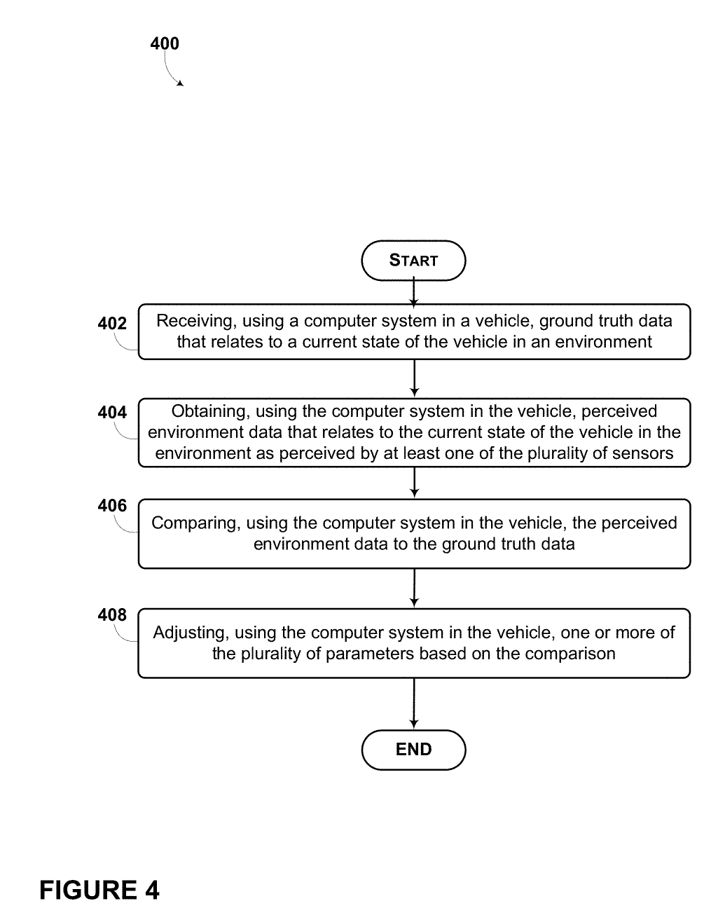

A method 400 is provided for receiving ground truth data that relates to a current state of the vehicle in an environment. A plurality of sensors are coupled to the vehicle and are controlled by a plurality of parameters. The vehicle is configured to operate in an autonomous mode in which the computer system controls the vehicle in the autonomous mode based on the data obtained by the plurality of sensors. The method also provides for obtaining perceived environment data that relates to the current state of the vehicle in the environment as perceived by at least one of the plurality of sensors, comparing perceived environment data to the ground truth data, and adjusting one or more of the plurality of parameters based on the comparison. The method could be performed using the apparatus shown in FIGS. 1 and 2 and described above; however, other configurations could be used. FIG. 4 illustrates the steps in an example method, however, it is understood that in other embodiments, the steps may appear in a different order, and steps could be added or subtracted.

Step 402 includes receiving, using a computer system in a vehicle, ground truth data that relates to a current state of the vehicle in an environment. The vehicle described in this method may also be configured to operate in an autonomous mode in which the computer system in the vehicle controls the vehicle in the autonomous mode based on data obtained by the plurality of sensors. The vehicle described in this method may be the automobile 100 and/or automobile 200 as illustrated and described in reference to the FIGS. 1 and 2, respectively, and will be referenced as such in discussing method 400. Receiving ground truth data that relates to a current state of the automobile in an environment may include, for example, receiving information about the position of other vehicles in the environment, the speed of other vehicles in the environment, a position of an obstacle in the environment, a position of a landmark in the environment, and a terrain map of the environment. In other examples, the ground truth data may include data regarding the sensors. For example, the ground truth data may include data indicating a location and operating altitude of a camera sensor. Other types information could be included in the ground truth data. The ground truth data may take the form of any data set and may be received by the computer system of the automobile to compare and/or validate the integrity of any data that is obtained or collected by one of the plurality of sensors of the automobile.

In some instances the ground truth data may be obtained directly from the automobile. For example, one of the plurality of sensors may be a confirmed reliable data source used to obtain the ground truth data. The ground truth data may be obtained by the sensor while the automobile is operating in manual or an autonomous mode, for example. In other examples, the ground truth data may comprise a database used as a supplemental data source. For example, ground truth data that pertains to location may be a database that provides a set of latitude and longitude information that can be used as an overlay guide, which may be compared and matched to any location data perceived by one of the plurality of sensors of the automobile. In yet further examples, the ground truth data may be obtained by any data collection device capable of collecting reliable data and communicating that data to the computer system of the automobile. Other means for the automobile to receive ground truth data are possible and contemplated herein.

Step 404 includes obtaining, using the computer system in the vehicle, perceived environment data that relates to the current state of the vehicle in the environment as perceived by at least one of the plurality of sensors. In other words, the computer system may control the automobile to operate at least one of the plurality of sensors to collect perceived data about the environment of the automobile as the automobile operates in an autonomous mode. For example, referring to the example in step 402, the automobile may make its own determination of the speeds of the other vehicles in the environment of the automobile.

Step 406 includes comparing, using the computer system in the vehicle, the perceived environment data to the ground truth data. For example, the automobile may compare the perceived position of the landmark in the environment to the position provided in the ground truth data. The comparison may occur, for example, by plotting the perceived location of the landmark in the environment and using longitudinal and latitudinal information provided in the ground truth data to verify that location. In other examples the comparison may be a rough comparison made only to validate whether the sensors are working properly. For example, the ground truth data may comprise data indicating the automobile is driving on a surface road in a straight line. The ground truth data may also include data indicating that the automobile is operating a laser that is mounted on top of the automobile with a certain calibration. The perceived data (perceived by the laser) may indicate that the automobile is drifting. In this instance, comparing the perceived data and the ground truth data may only include noting that the automobile is perceived to be drifting, but without reference to degree. Accordingly, it may be determined that the laser is not calibrated correctly, for example.

Step 408 includes adjusting, using the computer system in the vehicle, one or more of the plurality of parameters based on the comparison. The parameters may be adjusted, for example, in a manner so as to reduce a difference between the perceived environment data and the ground truth data. To do so, the computer system of the automobile may adjust the parameter value controlling the parameter. In other examples, the user may adjust the parameter value. In one example, a latency parameter may be adjusted to allow the perceived speeds of the other vehicles to accurately reflect the speeds of the other vehicles provided in the ground truth data. In this instance, the parameter value may be a numeric value that is reduced thereby changing the parameter to allow a sensor detecting the other vehicles to operate with reduced latency. Other parameter values may be adjusted. In some examples, multiple parameter values may be adjusted thereby adjusting multiple parameters that control the plurality of sensors. In other examples no parameter values may be adjusted. The parameter values may include a numeric value, a boolean value, a word, or a range, for example.

In one example, the rotation of a laser rangefinder may be adjusted to calibrate the laser based on the ground truth data. For example if, referring to FIG. 3A, the automobile 302 is operating a laser instead of a camera, and the laser is mounted directly on top of the automobile 302, which is travelling in a straight north heading, then the laser should produce pulses (i.e., data from the laser scanning over time) that indicate a straight road. If, however, the pulses depict point clouds in a different manner then the estimation of the laser orientation is not correct. In this instance, the laser may be adjusted via a parameter value using the computer system of the automobile 302 until the laser generates pulses indicating a straight road.

In another example, a wheel encoder may be used to measure (1) the velocity of the automobile and (2) the distance the wheel of the automobile has traveled. Having ground truth data representing the actual velocity of the automobile and the distance the wheel has actually traveled, it may be determined whether the wheel encoder is properly set. When it is determined that the wheel encoder is not properly set, the wheel encoder may be adjusted by, for example, using a parameter value to reset the wheel encoder. In other examples, the position and/or operating angle of any one of the sensors of the sensor system of the automobile may be adjusted using parameter values based on the ground truth data.

Example methods, such as method 400 of FIG. 4 may be carried out in whole or in part by the automobile and its subsystems. Accordingly, example methods could be described by way of example herein as being implemented by the automobile. However, it should be understood that an example method may be implemented in whole or in part by other computing devices. For example, an example method may be implemented in whole or in part by a server system, which receives data from a device such as those associated with the automobile. Other examples of computing devices or combinations of computing devices that can implement an example method are possible.

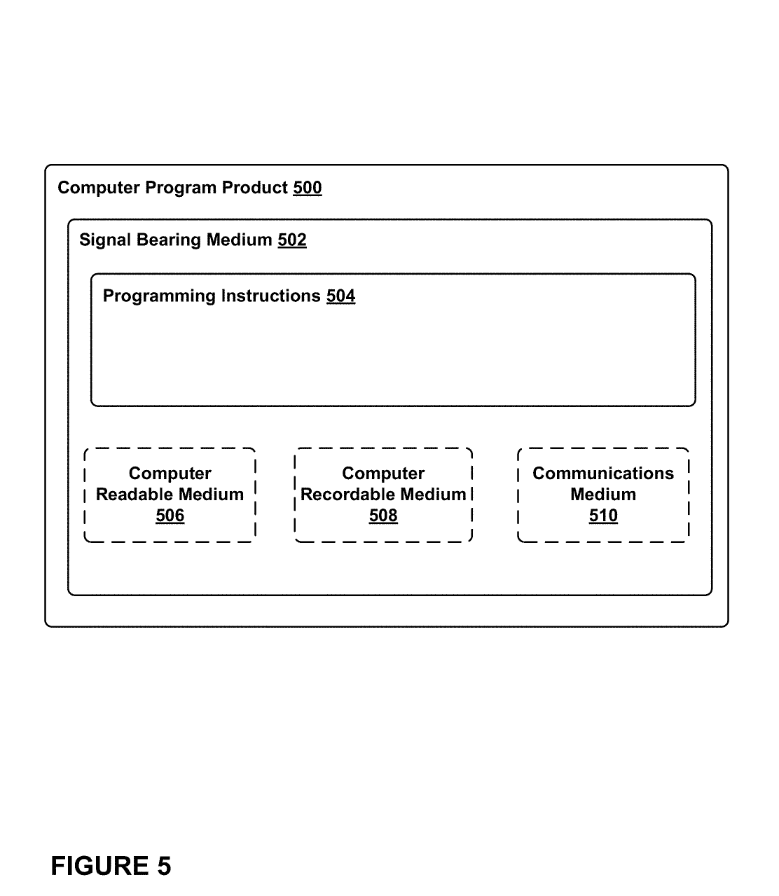

In some embodiments, the disclosed methods may be implemented as computer program instructions encoded on a non-transitory computer-readable storage media in a machine-readable format, or on other non-transitory media or articles of manufacture. FIG. 5 is a schematic illustrating a conceptual partial view of an example computer program product that includes a computer program for executing a computer process on a computing device, arranged according to at least some embodiments presented herein.

In one embodiment, the example computer program product 500 is provided using a signal bearing medium 502. The signal bearing medium 502 may include one or more programming instructions 504 that, when executed by one or more processors may provide functionality or portions of the functionality described above with respect to FIGS. 1-4. In some examples, the signal bearing medium 502 may encompass a computer-readable medium 506, such as, but not limited to, a hard disk drive, a Compact Disc (CD), a Digital Video Disk (DVD), a digital tape, memory, etc. In some implementations, the signal bearing medium 502 may encompass a computer recordable medium 508, such as, but not limited to, memory, read/write (R/W) CDs, R/W DVDs, etc. In some implementations, the signal bearing medium 502 may encompass a communications medium 510, such as, but not limited to, a digital and/or an analog communication medium (e.g., a fiber optic cable, a waveguide, a wired communications link, a wireless communication link, etc.). Thus, for example, the signal bearing medium 502 may be conveyed by a wireless form of the communications medium 510.

The one or more programming instructions 504 may be, for example, computer executable and/or logic implemented instructions. In some examples, a computing device such as the computer system 112 of FIG. 1 may be configured to provide various operations, functions, or actions in response to the programming instructions 504 conveyed to the computer system 112 by one or more of the computer readable medium 506, the computer recordable medium 508, and/or the communications medium 510.

The non-transitory computer readable medium could also be distributed among multiple data storage elements, which could be remotely located from each other. The computing device that executes some or all of the stored instructions could be an automobile, such as the automobile 200 illustrated in FIG. 2. Alternatively, the computing device that executes some or all of the stored instructions could be another computing device, such as a server.

The above detailed description describes various features and functions of the disclosed systems, devices, and methods with reference to the accompanying figures. While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method comprising:
receiving, using a computer system in a vehicle, ground truth data that relates to a current state of the vehicle in an environment, wherein the vehicle is configured to operate in an autonomous mode in which the computer system controls the vehicle in the autonomous mode based on data obtained by a sensor coupled to the vehicle, and wherein the sensor is a RADAR unit, a LIDAR unit, or a camera;
obtaining, using the computer system in the vehicle, perceived environment data that relates to the current state of the vehicle in the environment as perceived by the sensor;
detecting, using the computer system in the vehicle, a difference between the perceived environment data and the ground truth data; and
adjusting, using the computer system in the vehicle, one or more parameters of the sensor to reduce the difference between the perceived environment data and the ground truth data, wherein the one or more parameters include a latency of the sensor, a position of the sensor, or an orientation of the sensor relative to the vehicle.

2. (canceled)

3. The method of claim 1, wherein the ground truth data comprises known attributes of the environment relative to the vehicle.

4. The method of claim 3, wherein the known attributes of the environment relative to the vehicle comprise one or more of a position of another vehicle in the environment, a speed of the another vehicle in the environment, a position of an obstacle in the environment, a position of a landmark in the environment, and a terrain map of the environment.

5. The method of claim 4, wherein the perceived environment data comprises one or more of the position of the another vehicle in the environment, the speed of the another vehicle in the environment, the position of the obstacle in the environment, the position of the landmark in the environment, and the terrain map of the environment.

6. (canceled)

7. The method of claim 1, wherein the parameter value comprises a numeric value, a boolean value, a word, or a range.

8. A vehicle comprising:
a sensor coupled to the vehicle, wherein the sensor is a RADAR unit, a LIDAR unit, or a camera; and
a computer system, wherein the computer system is configured to:
control the vehicle in an autonomous mode based on data obtained by the sensor;
receive ground truth data that relates to a current state of the vehicle in an environment;
obtain perceived environment data that relates to the current state of the vehicle in the environment as perceived by the sensor;
detect a difference between the perceived environment data and the ground truth data; and
adjust one or more parameters of the sensor to reduce the difference between the perceived environment data and the ground truth data, wherein the one or more parameters include a latency of the sensor, a position of the sensor, or an orientation of the sensor relative to the vehicle.

9. (canceled)

10. The vehicle in claim 8, wherein the ground truth data comprises known attributes of the environment relative to the vehicle.

11. The vehicle in claim 10, wherein the known attributes of the environment relative to the vehicle comprise one or more of a position of another vehicle in the environment, a speed of the another vehicle in the environment, a position of an obstacle in the environment, a position of a landmark in the environment, and a terrain map of the environment.

12. The vehicle in claim 11, wherein the perceived environment data comprises one or more of the position of the another vehicle in the environment, the speed of the another vehicle in the environment, the position of the obstacle in the environment, the position of the landmark in the environment, and the terrain map of the environment.

13. (canceled)

14. The vehicle in claim 8, wherein the parameter value comprises a numeric value, a boolean value, a word, or a range.

15. A non-transitory computer readable medium having stored therein instructions executable by a computer system in a vehicle to cause the computer system to perform functions comprising:
receiving ground truth data that relates to a current state of the vehicle in an environment, wherein the vehicle is configured to operate in an autonomous mode in which the computer system controls the vehicle in the autonomous mode based on data obtained by a sensor coupled to the vehicle, and wherein the sensor is a RADAR unit, a LIDAR unit, or a camera;
obtaining perceived environment data that relates to the current state of the vehicle in the environment as perceived by the sensor;
detecting a difference between the perceived environment data and the ground truth data; and
adjusting one or more parameters of the sensor to reduce the difference between the perceived environment data and the ground truth data, wherein the one or more parameters include a latency of the sensor, a position of the sensor, or an orientation of the sensor relative to the vehicle.

16. (canceled)

17. The non-transitory computer readable medium of claim 15, wherein the ground truth data comprises known attributes of the environment relative to the vehicle.

18. The non-transitory computer readable medium of claim 15 wherein the known attributes relative to the vehicle of the environment comprise one or more of a position of another vehicle in the environment, a speed of the another vehicle in the environment, a position of an obstacle in the environment, a position of a landmark in the environment, and the terrain map of the environment.

19. The non-transitory computer readable medium of claim 18, wherein the perceived environment data comprises one or more of the position of the another vehicle in the environment, the speed of the another vehicle in the environment, the position of the obstacle in the environment, the position of the landmark in the environment, and the terrain map of the environment.

20. (canceled)
